(19) United States
(12) Patent Application Publication
(10) Pub. No.: US 2009/0160309 A1
(43) Pub. Date: Jun. 25, 2009

(54) Electron beam exit window

(76) Inventors: Dirk Burth, Odelzhausen (DE); Iris Burth, Odelzhausen (DE)

Correspondence Address: Pearne & Gordon LLP, 1801 East 9th Street, Suite 1200, Cleveland, OH, 44114-3108, US

(21) Appl. No.: 11/580,577

(22) Filed: Oct. 13, 2006

(30) Foreign Application Priority Data
Oct. 15, 2005 (DE) 10 2005 049 382

(51) Int. Cl. H01J 33/00; B44C 1/22

(52) U.S. Cl. 313/420; 216/24

(57) ABSTRACT

A process for producing an electron beam exit window for an electron beam accelerator is described. The process comprises reducing the thickness of a foil made of titanium or glass by etching the foil using an etching solution.

The invention relates to a method for the production of an electron beam exit window. In addition, the invention relates to an electron beam exit window, and to an electron beam accelerator.

The purpose of the invention is to provide an electron beam exit window (EBW) which, on the one hand, is very thin but, on the other hand, can be produced with sufficiently large dimensions to meet the respective requirements.

According to the invention, the method for producing an EBW includes a step to reduce the thickness of a titanium or glass foil. According to the invention, the thickness of the foil is reduced by etching the foil with an etching solution.

Electron beam exit windows for electron beam accelerators must meet two conflicting demands. First, the EBW must be thin enough not to slow down the exiting electrons too much. On the other hand, the EBW must withstand the pressure difference between the inner chamber of the electron beam accelerator and the atmospheric pressure of the surrounding air. In general, the use of thin electron beam exit windows allows a reduction of the voltage required to accelerate the electrons—thus resulting in a substantial reduction in cost. For example, as a result of the reduced accelerating voltage, the transformers used can be of smaller size. In addition, the construction measures required to screen the x-rays originating within the electron beam accelerator can also be reduced.

The thinner the EBW is, the less energy it absorbs. Therefore, the use of thin electron beam exit windows results in only little heat. Thus the electron beam accelerator can be run with an increased dosage rate through the use of a thin EBW.

An additional advantage of using thin EBWs is that, as a result of the decreased acceleration voltage, the substrate on to which the electrons impinge is damaged less than when a high acceleration voltage is used.

For this reason, it has been attempted to use thin metal foils—made by rolling—as electron beam exit windows. By means of a rolling process, it is e.g. possible to produce titanium foils with a thickness of about 10-12 μm. However, when trying to produce even thinner foils, the limits of the rolling process are reached. When one attempts to roll a titanium foil thinner than 10 μm, the foil is subjected to extensive mechanical strain—which leads to tears and holes. This type of titanium foil cannot be used for electron beam exit windows. At the best, only small pieces of foil can be made by means of rolling. However, it is precisely the larger EBWs which are of interest—those of a suitable size for the machines currently used in the fields of printing and finishing.

In another well-known technique, an oxide, nitride, or carbide layer of uniform thickness is applied to a carrier. This can be done, for example, by oxidation of the carrier, or by vapour deposition. The carrier, which might e.g. be made of metal or silicon, is then completely removed by etching. The layer of oxide, nitride, or carbide which remains can be used as an electron beam exit window. The disadvantage of this process is that small holes (so-called pin-holes) form during the production of the oxide, nitride, or carbide layers. As yet, only small EBWs—for example, measuring less than 5 cm—could be produced successfully by means of this technique. A further disadvantage of this method is that the production of the additional layer of oxide, nitride, or carbide on the carrier involves a great deal of work and expense.

In the method according to this invention, the thickness of an already-existing titanium or glass foil is reduced—in a controlled manner—by means of an etching solution. In contrast to the techniques of the prior art, the titanium or glass foil does not serve as a carrier for an applied layer, which later becomes the actual EBW. The titanium or glass itself is the material which constitutes the electron beam exit window. Here, etching does not mean the total removal of a carrier but the controlled reduction of the thickness of the material which forms the EBW.

In the manufacturing process according to this invention, the already very thin layer of titanium or glass is not removed completely, but only reduced in thickness. One would expect that etching of the already-thin foils would cause unevenness, inhomogeneity, and the formation of holes. However, none of this happens. It has been found that—by choosing a suitable concentration of the etching solution—an even processing could be achieved, in which the thickness of the titanium or glass foil is homogeneously reduced as a function of time. With suitable processing, tears, holes, or mechanical instabilities do not occur. As a result of the method used in this invention, a titanium or glass foil is obtained which has a thickness in the range of some micrometers. Such foils are able to withstand mechanical stress and, particularly, the difference of pressure within an electron beam accelerator. This is because glass or titanium are homogenous materials—without inner tensions—having been reduced evenly by the etching process. Titanium and glass are preferred materials for EBWs, because of their resistance to radiation and corrosion.

By means of the method used in the invention, electron beam exit windows, which function reliably—and with a thickness in the range of some micrometers —can be produced in any dimensions. As no holes or tears appear in the foil during the production process, windows produced by this method are not subject to any limitation in size. Therefore, it is possible to produce electron beam accelerators which are able to cover the entire web width of commonly-used printing and finishing machines.

According to a preferred embodiment of the invention, the foil is etched using an acidic solution containing fluoride, or hydrofluoric acid. According to another preferred embodiment, the concentration of the hydrofluoric acid can range from 0.1-10%. The concentration of the hydrofluoric acid determines the rate of etching of the titanium or glass foil. If the concentration is too high, the rate of etching is too fast, and holes appear in the foil. However, with an etching solution of too low a concentration, the process takes too long.

According to a preferred embodiment of the invention, the thickness of the foil on completion of etching is determined by the reaction time of the etching solution and the concentration of the solution used. For example, the time required to remove 1 μm of titanium or glass can be determined empirically, and can later be used as a basis for the calculation of the reaction time.

Preferably, the foil is cleaned and degreased before etching. Further preferably, the foil is rinsed with sodium hydroxide and/or with water after etching. According to another preferred embodiment, a solution of sulphuric acid, or a mixture of sulphuric acid and hydrogen peroxide is used to remove the compounds which remain after etching. Using these chemicals, fluoride salts which remain on the surface of the etched electron beam exit window can be removed. These fluoride salts have to be removed, as they lead to corrosion later.

Preferably, the foil is fixed in a frame. In this way, formation of kinks and wrinkles in the foil—resulting from mechanical stress—can be prevented. Further preferably, the foil is etched while being fixed in the frame. For this purpose, the frame might e.g. be filled with etching solution. Further preferably, the foil is transported while being fixed in this frame. Preferably, the foil is inserted together with its frame in the electron beam accelerator, thus ensuring a stable mechanical fixation of the foil during the entire treatment. Preferably, the frame itself is already a supporting construction for holding the foil in the electron beam accelerator.

According to a preferred embodiment, the thickness of the foil is reduced by etching both sides of the foil simultaneously. In this procedure, only a small amount of material has to be removed at each side, so that tolerances are less strict than if only one side is etched.

According to a further preferred embodiment, the glass or titanium foil is selectively etched only at predetermined regions. At these regions, the thickness of the foil is diminished, whereas the thickness of the rest of the foil remains unchanged. By selective etching of the foil, the stability of the resulting electron beam exit window can be improved. Furthermore, the heat produced can be dissipated more effectively by thicker structures. Further preferably, the thickness of the foil is reduced in a way that corresponds to the openings in the supporting structure. Later, the foil—together with the supporting structure—is inserted into the electron beam accelerator. Hence it is only necessary to reduce the thickness of the layer in the areas corresponding to the openings in the supporting structure, whereas the thickness of the foil can remain unchanged in the supported places.

According to a preferred embodiment, the process can be applied to the production of EBWs of any size. For example, the produced EBW can be over 10 cm in length and 2 cm in width. With the use of such EBWs, it is possible to construct an electron beam accelerator which can cover the entire width of the web of a printing or finishing machine with one single electron beam exit window.

According to a preferred embodiment, the foil is a titanium foil. According to a further preferred embodiment, at first, the oxide layer of the titanium foil is removed—either by etching with hydrofluoric acid, or with a mixture of acid and fluoride salt. Such an oxide layer, which typically has a thickness of several nanometres, is formed when the titanium foil is in contact with atmospheric oxygen. Only after removal of this passivation layer by etching, can the reduction of the titanium be started. Preferably, the titanium is also etched with the hydrofluoric acid (or the mixture of fluoride salt and acid) that was used to remove the oxide layer. Alternatively, after removal of the passivation layer, a different acid—such as hydrochloric acid or sulphuric acid—may be used to etch the titanium.

Preferably, the reduction of the titanium foil's thickness is monitored during the etching process. This can e.g. be done by measuring the electrical resistance of the titanium foil. Alternatively, the electrical resistance of the etching solution might e.g. be monitored. According to a further preferred embodiment, the concentration of the acid or the dissolved titanium compounds is determined by spectrometrical measurement of the concentration of suitable indicators.

According to a preferred embodiment, the foil is a glass foil. The advantage of using glass or SiO₂ as material for windows is its low density, which makes it possible to further reduce the acceleration voltage.

Preferably, the glass foil is made by thermal spraying, melting or pouring molten glass onto a metal carrier, or by gluing a glass plate to a metal carrier. By means of these techniques, layers of glass with a thickness of between e.g. 50 μm and 150 μm can be produced with any dimensions. Such layers of glass are very suitable as a starting material for the etching process according to the invention. Preferably, before the etching process, the thickness of such a layer of glass is reduced mechanically—for example by grinding, polishing, or electro-polishing.

An electron beam accelerator according to the invention includes a cathode or a filament, an acceleration anode, and a high-voltage source for generating an accelerating voltage applied between the cathode and the anode. In addition, the electron accelerator contains an electron beam exit window, which is made using the method described above. By a thin EBW, the thermal strain on the window is reduced. As a result, the electron beam accelerator can work at a higher dose rate.

According to a preferred embodiment, the accelerating voltage is lower than, or equal to, 70 kV. Because of the lower thickness of the EBW, the electrons penetrating the electron beam exit window are weakened less—thus the accelerating voltage can be reduced. As a result, the transformer needed to generate the accelerating voltage can be of smaller size, and costs less. Also because of the lower accelerating voltage, the requirements for the shielding used as a protection against high-energy radiation may be reduced as well. In particular, the shielding can be smaller and more compact. The application of a lower accelerating voltage is of particular advantage if the electron beam accelerator is used to cure coatings. Because of the lower acceleration voltage, the coating absorbs a major part of the electrons, thus the underlying substrate is damaged less.

Preferably, the electron beam accelerator is used for electron-beam curing of varnishes, coatings, printing inks, or adhesives, as well as for the crosslinking of plastic material.

In the following, the invention is further described, referring to several embodiments shown in the drawings.

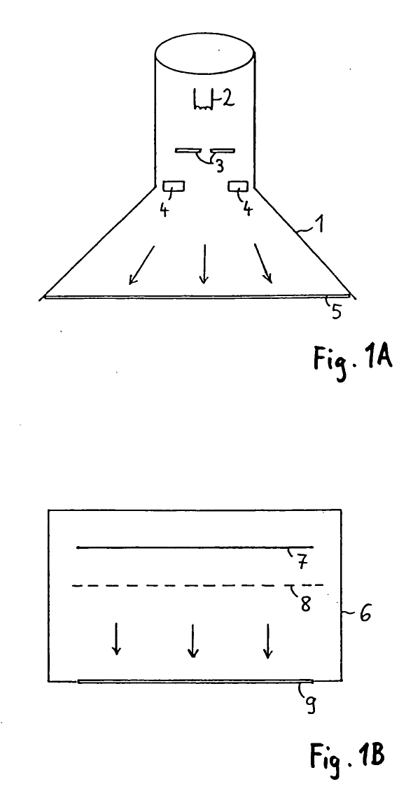

FIG. 1A shows a first embodiment of an electron beam accelerator;

FIG. 1B shows a second embodiment of an electron beam accelerator;

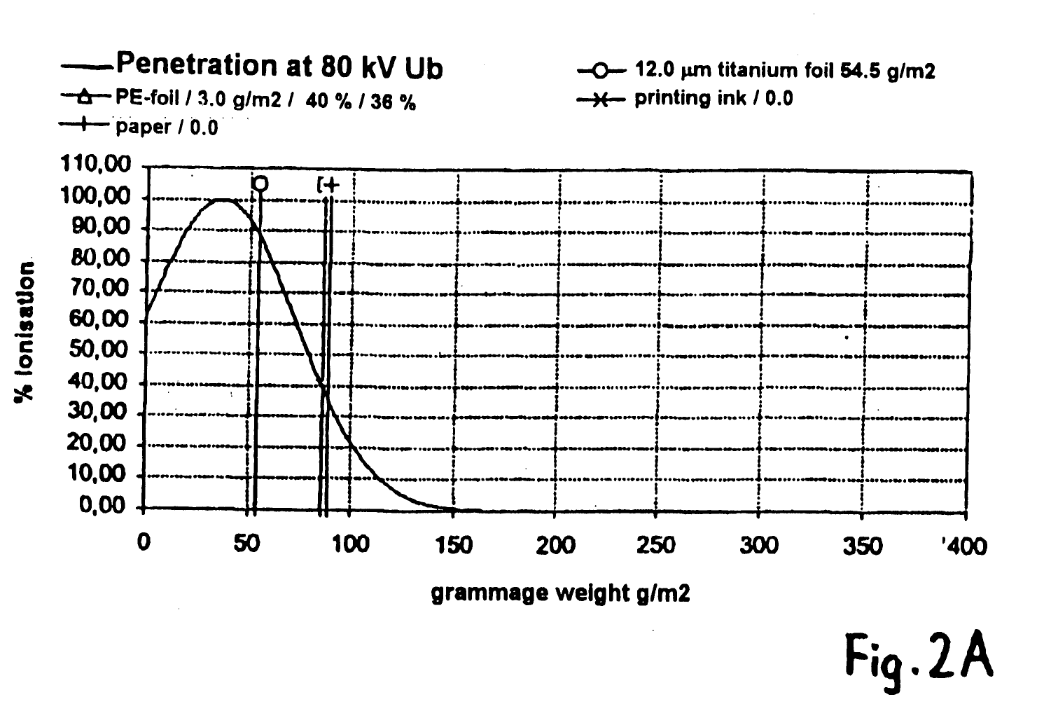

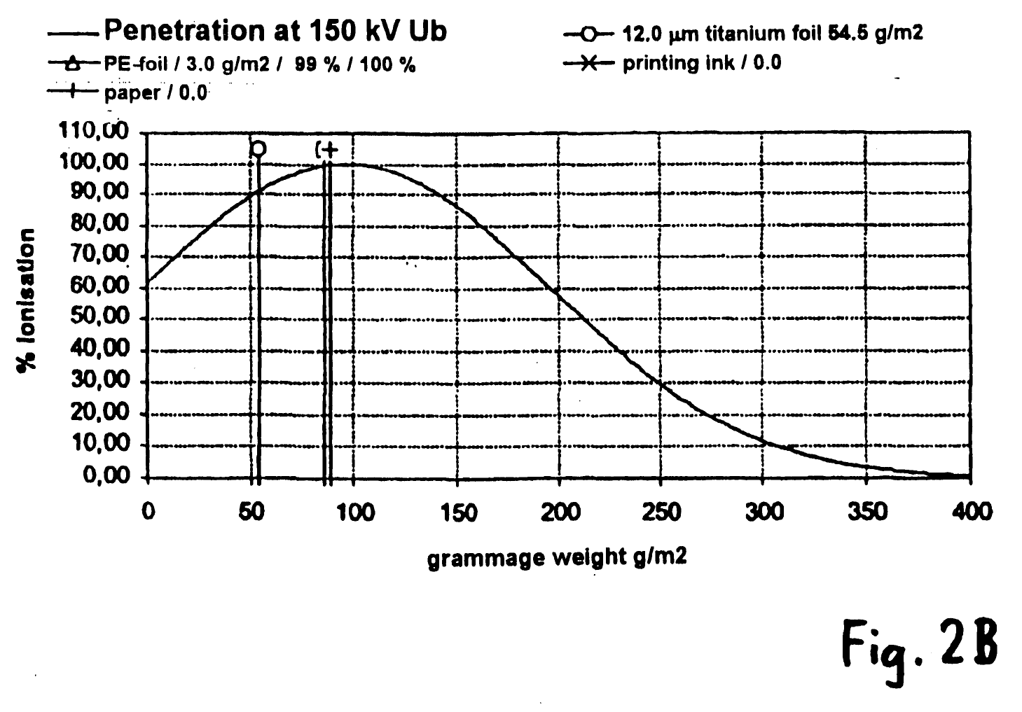

FIG. 2A indicates the penetration of electrons through the radiated layers at an acceleration voltage of 80 kV;

FIG. 2B indicates the penetration of electrons through the radiated layers at an acceleration voltage of 150 kV;

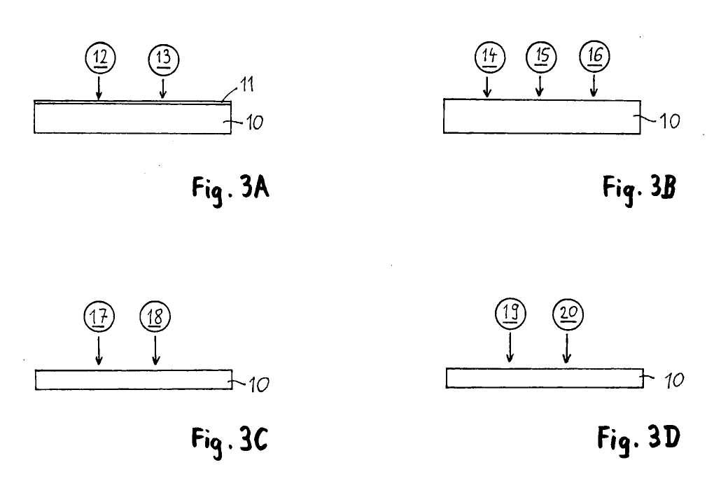

FIG. 3A illustrates a first step in the production process according to the invention—in which the oxide layer on the titanium foil is removed;

FIG. 3B illustrates a second step in the production process according to the invention—in which the thickness of the titanium foil is reduced by etching;

FIG. 3C illustrates a third step in the production process according to the invention—in which the etched titanium foil is rinsed;

FIG. 3D illustrates a fourth step in the production process according to the invention—in which remaining titanium compounds are removed from the surface of the titanium foil;

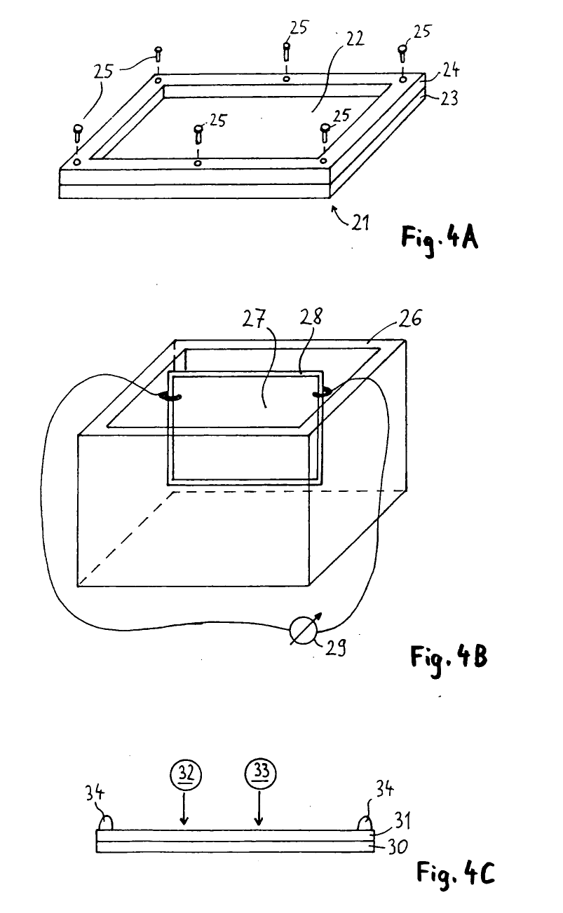

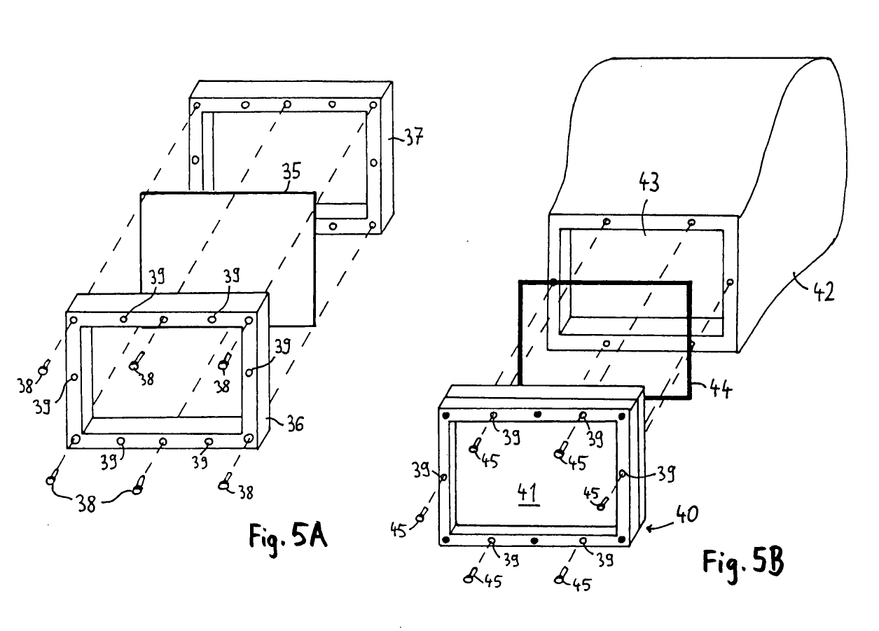

FIG. 4A shows a first method of carrying out the etching process;

FIG. 4B shows a second method of carrying out the etching process;

FIG. 4C shows a third method of carrying out the etching process;

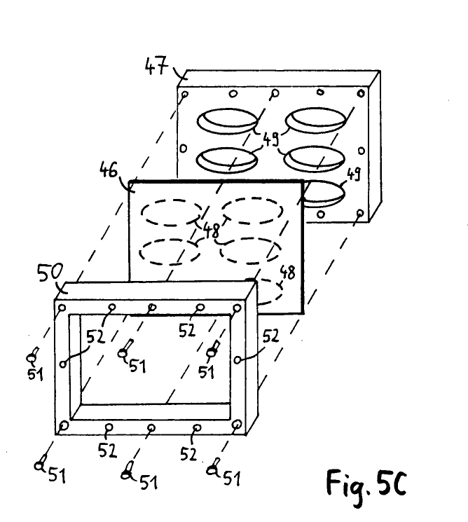

FIG. 5A shows fixing the electron beam exit window in a frame;

FIG. 5B shows installation of the electron beam exit window with the frame into an electron beam accelerator;

FIG. 5C shows fixing the EBW by means of a supporting structure;

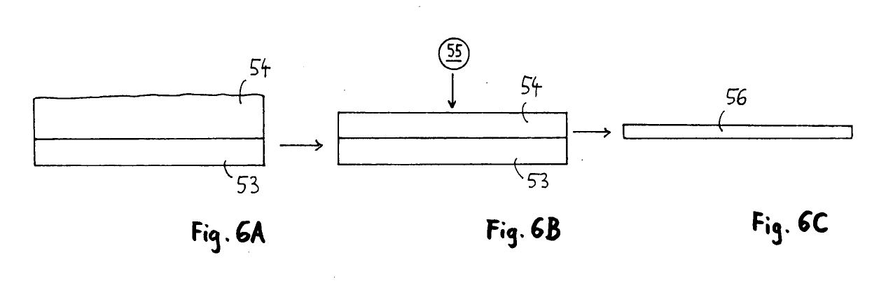

FIG. 6A illustrates a first step in the production of a glass EBW;

FIG. 6B illustrates a second step in the production of a glass EBW;

FIG. 6C illustrates a thin glass foil obtained as a result of the production process.

Electron beam accelerators are appliances, in which electrons are accelerated by high voltage. The electron beam accelerators are used technically for various purposes, e.g. for electron-beam welding, or sterilization, as well as to cure varnishes, coating materials, printing inks or adhesives.

Electron accelerators for the above-mentioned applications—usually called electron beam accelerators—are constructed analogous to a cathode-ray tube. They consist of an incandescent cathode from which electrons are emitted at high temperature. These are accelerated in an electric field and are deflected to the desired position by means of a magnetic or electric field. The appliance is operated at low pressure—less than 10⁻⁴ bar—so that the electrons can be accelerated unimpeded. For curing coating materials or adhesives, the electrons have to leave the electron beam accelerator. In order to achieve this efficiently, window material consisting of a 10 μm to 12 μm thick titanium foil is commonly used—this foil is permeable to electrons. The EBW therefore constitutes a barrier between the atmosphere outside and the vacuum (low-pressure below 10⁻⁴ bar).

In FIG. 1A and FIG. 1B, two different types of electron beam accelerators are shown. Inside the housing 1 of the electron beam accelerator shown in FIG. 1A, an incandescent cathode 2 and an acceleration-anode 3 are positioned. A voltage applied between the incandescent cathode 2 and the acceleration anode 3 accelerates the electrons emitted by the incandescent cathode 2. Along the electron beam path, deflecting magnets 4 which spread the beam are located. The electrons leave the electron beam accelerator through the electron beam exit window 5.

Inside the housing 6 of the electron beam accelerator shown in FIG. 1B, a filament 7 as well as an acceleration-anode 8 are located. Between the filament 7 and the acceleration anode 8, there is a voltage to accelerate the electrons leaving the filament. The accelerated electrons leave the electron beam accelerator through the EBW 9. The entire electron beam accelerator, as well as the area in which the substrate is radiated, is enclosed in a lead jacket. This is necessary in order to protect against X-rays, which arise in the process, during the slowing down of the electrons.

The applied acceleration voltage determines the energy level of the X-rays generated by the slowing down of the electrons. The higher the acceleration voltage, the higher the energy of the x-rays and accordingly, the thicker the lead jacket required for the protection against radiation.

When used for curing varnishes, coating materials, printing inks, or adhesives, electron beam curing (EBC) has a number of advantages, as compared with other hardening processes, such as UV-curing. Due to the high degree of chemical crosslinking achieved, especially hard and chemically resistant layers are obtained. Also, with EBC, the curing of very thick films is possible, because the radiation can penetrate the substrates, and pigments in varnishes or printing inks cause hardly any problems when cured. A further advantage of EBC, as compared with UV-curing, is that it does not require expensive photo-initiators.

The disadvantage of the electron beam accelerator is the high cost of acquisition. This is largely due to the very high cost of the transformer required for the generation of voltages higher than, or equal to, 80 kV. The high cost of transformers is based on the fact that transformers of such performance are produced only individually. In comparison, transformers that provide voltage up to 70 kV are considerably cheaper, as these are used in large numbers, e.g., for x-ray equipment. A further significant reason for the cost is the lead jacket. There, too, the cost depends on the acceleration voltage used. The electron acceleration voltage determines the depth to which the electrons penetrate the layers which are to be hardened.

The depth of electron penetration is shown in FIG. 2A and FIG. 2B. FIG. 2A shows a penetration graph, i.e., electron penetration as a function of the grammage weight of the radiated layer(s)—with an acceleration voltage of 80 kV. In contrast, FIG. 2B depicts a penetration graph for electrons accelerated by a voltage of 150 kV.

It is apparent that the electrons are slowed down by every substance in their path. In the standard EBC appliance, the slowing down of electrons results firstly from the electron beam exit window, and secondly from the air gap between the coating material and the exit window, as well as from the coating itself.

A significant factor determining the minimum acceleration voltage is the thickness and density of the electron beam exit window used. In the case of the previously used 10 μm to 12 μm titanium foils, a voltage of at least 80 kV was required in order to cure a layer of printing ink of 5 μm thickness.

Titanium foils can, for example, be made by rolling. In this process, the mechanical stress exerted upon the titanium foil prevents producing thin titanium foils with larger dimensions. At a thickness of less than 10 μm, only foils of the dimensions 10 cm×10 cm are commercially available. An EBC appliance that is used with a standard finishing machine requires an electron beam exit window having a minimum width of 1 m. For an EBC appliance used in a small label-printing press, a minimum window width of the window material of more than 25 cm is required.

According to a first embodiment of the invention, a titanium foil with a thickness of less than 10 μm is used for an electron beam exit window. In order to produce such an EBW, the thickness of a thicker titanium foil, which serves as starting material, is reduced by etching.

The production process of an electron beam exit window, according to the invention is illustrated in FIG. 3A to FIG. 3D. As starting material, a titanium foil 10 with a thickness of up to 50 μm—as is commercially available—is used. Preferably, before the etching process, the titanium foil should be cleaned and degreased. Because of contact with the surrounding air, the titanium foil is usually covered with a thin layer of titanium oxide 11. In the first step, shown in FIG. 3A, the titanium oxide layer 11 is etched by treating the surface of the titanium foil with an etching solution. For this purpose, hydrofluoric acid 12, for example, can be applied to the surface of the titanium foil. The concentration of the hydrofluoric acid 12 preferably lies between 0.1% and 10%. Alternatively, a mixture 13 of an arbitrary acid and a fluoride salt may be used for etching the titanium oxide layer 11. As an acid, sulphuric acid or hydrochloric acid may e.g. be used, and sodium fluoride is a suitable fluoride salt, for example. Preferably, the respective concentration of the acid and the fluoride salt should be between 1% and 10%. The fluoride salt need not necessarily have the same concentration as the acid.

In FIG. 3B, the titanium foil 10 is shown after the titanium oxide layer 11 has been removed by etching. In order to reduce the thickness of the titanium foil still further, the titanium foil 10 is treated with an etching solution for a certain time. As an etching solution, hydrofluoric acid 14 with a concentration between 0.1% and 10% or a mixture 15 of fluoride salt and an acid with a concentration of 0.1%-10%, may be used. Hence, the acid used to etch the titanium oxide layer 11—as shown in FIG. 3A—may be used for the further etching process. Alternatively, after removal of the titanium oxide layer 11, the titanium foil 10 might as well be etched with a different acid 16, for example, hydrochloric acid or sulphuric acid. While etching the titanium foil 10, the release of gas can be seen. This gas is hydrogen, which results from the etching. The longer the influence of the respective acid on the titanium foil 10, the more material is removed. For example, when a solution of 3% hydrofluoric acid is used, the rate of the removal of the titanium is 1 μm per 25 sec. However, this linear rate of removal of the layer's thickness as a function of time, can be observed only if there is a large surplus of hydrofluoric acid in relation to the amount of titanium. Otherwise the rate of the etching process decreases with time.

When the etching solution has been in contact with the titanium foil 10 for a certain time, sufficient material is removed, and the thickness of the titanium foil 10 has been reduced to the desired value. The etching process is then stopped and the respective etching solution is removed. As shown in FIG. 3C, the surface of the titanium foil 10 is then rinsed one or several times. To rinse the foil, it is possible—for example—to use a 50% sodium hydroxide solution to neutralise the residual acid. In this way, the etching process can be stopped reliably. Alternatively or additionally, the surface of the titanium foil 10 may be rinsed with water 18 after the etching process. Preferably, the titanium foil 10 is rinsed several times after the etching process.

In FIG. 3D, another follow-up treatment of the etched titanium foil 10 is shown. This treatment serves to remove any remaining titanium compounds after the etching process. For this purpose, the surface of the titanium foil 10 is rinsed with a solution 19 of sulphuric acid, or with a mixture 20 of sulphuric acid and hydrogen peroxide.

By means of the production process shown in FIGS. 3A to 3D, a titanium foil with a thickness between 1 μm and 9 μm can be produced—this is especially suitable for an EBW for an electron beam accelerator. Because it is very thin, the etched titanium foil shows a high permeability to accelerated electrons. Furthermore—although it is very thin, the etched titanium foil is able to withstand the difference of pressure between the vacuum in the inner chamber of the electron beam accelerator and the atmospheric pressure outside. As a result of the homogeneous etching process, a uniform thickness of the etched titanium foil is achieved. In particular, in the production process according to the invention, the formation of small holes (so-called pinholes) or tears can be avoided.

FIG. 4A shows a frame unit 21 to hold the titanium foil 22 which simplifies the handling of the thin foil and may further be used as an etching trough for etching the titanium foil 22. The frame unit 21 may e.g. comprise a lower frame 23 and an upper frame 24. The titanium foil 22 is clamped between the lower frame 23 and the upper frame 24. In order to seal the frame unit 21 additionally, a frame-shaped seal—consisting, for example, of Teflon or silicone can also be fitted. The lower frame 23 is screwed to the upper frame 24 by means of screws 25. Through the use of the frame unit 21, the formation of creases in the titanium foil 22—which would render impossible a homogeneous and pinhole-free etching of the titanium foil 22—can be prevented.

Hydrofluoric acid, or a mixture of a fluoride salt and an acid, is poured from above into the frame unit 21, in order to etch the upper surface of the titanium foil 22 for a certain period of time. Hence only the upper surface of the titanium foil 22 is etched, while the lower surface remains unchanged. In order to attain a more even reduction of the thickness of the foil—and thus reduce the danger of perforating the foil—the frame unit 21 can be turned upside down after the etching of the upper surface has been completed. In a subsequent second step, the other surface of the titanium foil 22 can then be etched. The use of a frame unit 21 has the advantage that the edges of the titanium foil 22 are covered by the frames 23, 24 during the etching process, and are therefore not etched. In this way, after the etching process, a thick and robust border area remains, which stabilises the thin inner area of the titanium foil 22. As an alternative to a solid frame, a frame made of plastic modelling-material can be used—this material is self-adhesive and acts as a seal.

In FIG. 4B, an alternative approach for carrying out the etching process is illustrated. In this, the respective etching solution used—for example, hydrofluoric acid, or a mixture of a fluoride salt and an acid—is poured into an acid-resistant etching vessel 26. The titanium foil 27 is then immersed in the etching solution for a certain period of time—in order to etch both the lower side and the upper side of the titanium foil 27 simultaneously. The simultaneous etching of both surfaces of the titanium foil 27 reduces the risk of pinhole formation. As shown in FIG. 3A, before the actual etching of the foil 27, at first, the titanium oxide layer must be etched from both sides. After removal of the titanium oxide layer, the titanium itself is attacked by the acid, and gas (hydrogen) starts to appear. This corresponds to the process step illustrated in FIG. 3B. During the etching process, the titanium foil 27 may e.g. be stabilised by a frame 28, in order to pre-vent the formation of creases and mechanical instabilities.

The thickness of the titanium foil 27 depends both on the reaction time and on the concentration of the etching solution. The reduction of the thickness, as a function of time, may e.g. be determined empirically. For instance, it is known that, using a solution of 3% hydrofluoric acid, the removal of a titanium layer of 1 μm takes about 25 sec. For example, if the thickness of a titanium foil 27, which is initially 12 μm, is to be reduced to 5 μm, the reaction time of the etching solution will be about 175 sec. This applies only if there is a large surplus of hydrofluoric acid relative to the amount of titanium. Otherwise, the rate of the etching process decreases with time.

Alternatively or additionally, various methods of measurement can be used to determine the reduction in thickness of the titanium foil. For example, as shown in FIG. 4B, the electrical resistance of titanium foil 27 may be monitored by means of an ohmmeter 29. The electrical resistance of a conductor is indirectly proportional to its cross-section, and hence, the resistance of the titanium foil 27 increases as its thickness decreases. A further possibility is to follow the resistance of the etching solution as a function of time. In the course of the etching process, the concentration of ions in the etching solution changes, and as a result, the resistance of the etching solution decreases. A further possibility of following changes in the thickness of the titanium foil is to monitor the change of the composition of the etching solution during the etching process, by means of a spectroscope. For this purpose, indicators for acids or titanium compounds may be added to the etching solution, in order to follow the respective concentrations as a function of time.

FIG. 4C shows a further possibility of carrying out the etching process. In the variation depicted in FIG. 4C, a carrier foil 30 is laminated to a titanium foil 31, in order to improve the stability of the titanium foil and to prevent creases and other mechanical damages. Optionally, the titanium foil can be etched, on the side to which the carrier foil is to be attached, before lamination. For the etching, hydrofluoric acid 32 or a mixture 33 of a fluoride salt and an acid is poured in a frame 34. When the titanium foil 31 has been reduced to the desired thickness, the laminated carrier foil 30 may be removed from the titanium foil 31 mechanically, chemically, or thermally. Preferably, the carrier foil 30 is only removed after the transportation of the EBW, or after insertion of the EBW in an electron beam accelerator.

FIGS. 5A to 5C show how an etched titanium foil is first clamped into a frame, and how this frame together with the titanium foil is then inserted in an electron beam accelerator. FIG. 5A depicts how a titanium foil 35 is placed between a first frame 36 and a second frame 37, and is fixed with screws 38. The titanium foil used may be one the thickness of which has been reduced in a preceding etching process. Alternatively, as illustrated in FIG. 4A, etching of the titanium foil 35 may be carried out in the frame unit comprising the frames 36, 37. The frames 36, 37 have additional drilled holes, with which the frame unit can be fitted to the electron beam accelerator.

FIG. 5B shows how the frame unit 40, in which the etched titanium foil 41 is clamped, is fitted onto an electron beam accelerator 42. This is done by mounting the frame unit on the exit aperture 43 of the electron beam accelerator 42, from which the electrons leave after passage through the acceleration unit. As there is a vacuum within the electron beam accelerator, it may be necessary to insert a seal 44 between the frame unit 40 and the electron beam accelerator 42. By means of the additional drilled holes 39, the frame unit 40 may then be screwed on to the exit aperture 43 of the electron beam accelerator.

Although it is very thin, the titanium foil 41 is sufficiently stable to mechanically withstand the difference in pressure between the vacuum within the electron beam accelerator 42 and the atmospheric pressure outside of the electron beam accelerator 42. On account of the small thickness of the titanium foil 41 serving as an electron beam exit window, the accelerated electrons are slowed down only slightly while passing through the titanium foil 41. Because the electrons lose only a small amount of energy while passing through the titanium foil 41, the acceleration voltage of the electron beam accelerator 43 may be reduced. For example, an acceleration voltage of approximately 70 kV may suffice for many applications. The decrease in the acceleration voltage enables the use of smaller and cheaper transformers. Furthermore, the reduced acceleration voltage leads to less expense for material to screen off the x-rays originating in the electron beam accelerator 42. In addition, the use of a titanium foil, produced according to the invention, allows operation of the electron beam accelerator at a higher dose rate, because the thin titanium foil absorbs fewer electrons and therefore heats up less.

FIG. 5C shows another embodiment of the invention, in which the titanium foil 46 rests on a supporting structure 47. Because of the supporting areas of the structure, the area of unsupported titanium foil 46 is smaller in size. The force of the pressure on the titanium foil 46—resulting from the difference in the pressure inside and outside of the electron beam accelerator—is reduced considerably by the supporting structure 47. Furthermore, the supporting structure 47 may further be used to cool the titanium foil 46. For this purpose, channels through which cooling liquid flows can be incorporated in the supporting structure 47. In this way, the heat resulting from the absorption of radiation energy can be removed.

The titanium foil 46 shown in FIG. 5C can either be etched completely or only in those places 48 which correspond to the cut-out areas 49 in the supporting structure 47. Titanium foil 46 of the kind depicted in FIG. 5C can be made by selective etching, using an etching mask. The hydrofluoric acid, or the mixture of a fluoride salt and an acid, then has an effect only on the unsupported areas 48 of the titanium foil 46—thus the thickness of the titanium foil 46 is reduced in only these areas 48, by selective etching. The remaining areas of the titanium foil 46 are not etched, and so the original thickness remains unchanged. As a result, the mechanical stability of the electron beam exit window made in this way is increased.

To insert the partially-etched titanium foil 46 in an electron beam accelerator, the foil 46 is clamped between the supporting structure 47 and a frame 50. The frame 50 may e.g. be attached to the supporting structure 47 by means of screws 51. Then, the window unit—comprised of the frame 50, the titanium foil 46, and the supporting structure 47—may be screwed onto the exit aperture 43 of the electron beam accelerator 42 shown in FIG. 5B via the additional bore holes 52. Because of the difference in pressure inside and outside the accelerator, the titanium foil 46 is pressed against the supporting structure 47.

As already described, by etching titanium foil, a thin—but nevertheless stable electron beam exit window can be produced. According to an alternative embodiment of the invention, instead of a titanium foil, a glass foil is used, with the glass foil's thickness being reduced by etching. When using a glass foil, hydrofluoric acid, or a mixture of a fluoride salt and an acid, can be used as an etching solution. In order to produce a suitable glass foil as a starting material for the etching process, the technique of thermal spraying can be used—as shown in FIG. 6A. In this, a layer 54 of glass, SiOₓ, SiO₂, ceramics, SiC, or BN is applied to a metal carrier 53, which can, for example, be of aluminium. Then, the thickness of the applied layer is reduced by mechanical grinding and polishing. In a subsequent step shown in FIG. 6B, the thickness of the applied layer 54 is further reduced by treating with an etching solution 55. The metal carrier can then be removed—for example, by etching with an acid. FIG. 6C shows a thin glass foil 56, which is obtained as a result of these processing steps. The thin glass foil 56 can be used as an EBW of an electron beam accelerator. The advantage of using glass or SiO₂ as materials for windows is the low density, which enables a further reduction of the acceleration voltage.

1. Process for producing an electron beam exit window for an electron beam accelerator, characterized by
reducing the thickness of a foil made of titanium or glass by etching the foil using an etching solution.

2. Process according to claim 1, characterized by at least one of the following steps:
etching the foil using an acid or base;
etching the foil using an acidic solution containing fluoride;
etching the foil using hydrofluoric acid;
etching the foil using hydrofluoric acid having a concentration of between 0.1% and 10%;
etching the foil using a mixture of an acid and a fluoride salt;
etching the foil using a mixture of an acid and a fluoride salt wherein the respective concentrations of the acid and the fluoride salt are between 1% and 10%.

3. Process according to claim 1, characterized by at least one of the following steps:
cleaning the foil and removing grease there from before etching;
rinsing the foil after etching using sodium hydroxide solution;
rinsing the foil after etching using water;
removing compounds still remaining after etching using a solution of sulfuric acid or a mixture of sulfuric acid and hydrogen peroxide.

4. Process according to claim 1, characterized by dipping the foil into a caustic bath containing an etching solution in order to etch.

5. Process according to claim 1, characterized by at least one of the following steps:
immobilizing the foil in a frame;
etching the foil by filling the frame with an etching solution;
transporting the foil after the etching to an electron beam accelerator by means of the frame;
incorporating the frame with the foil in an electron beam accelerator.

6. Process according to claim 1, characterized by at least one of the following steps:
reducing the foil thickness by etching both sides of the foil at the same time;
reducing the foil thickness by etching a first side followed by etching a second side of the foil;
reducing the foil thickness by etching only one side of the foil;
reducing the foil thickness of the entire foil by etching;
reducing the foil thickness at predetermined areas by selectively etching the predetermined areas;
reducing the foil thickness according to the openings of a support structure with the foil remaining thick and stable at supported areas.

7. Process according to claim 1, characterized by at least one of the following features:
the foil is longer than 10 cm;
the foil is wider than 2 cm;
the thickness of the foil after etching is determined by the reaction time of the etching solution and the concentration of the etching solution.

8. Process according to claim 1, characterized by the foil being a titanium foil.

9. Process according to claim 8, characterized by one or more of the following features:
initially, the thickness of the titanium foil is between 7 μm and 35 μm;
upon completion of the etching process, the thickness of the titanium foil amounts to between 1 μm and 9 μm.

10. Process according to claim 8, characterized by at least one of the following steps:
removing an oxide layer from the titanium foil by etching using hydrofluoric acid or a mixture of hydrofluoric acid and a fluoride salt;
upon removing an oxide layer of the titanium foil, reducing the thickness of the titanium foil by etching using one of the following etching solutions: hydrochloric acid, sulfuric acid, hydrofluoric acid, a mixture of an acid and a fluoride salt;
monitoring the foil thickness of the titanium foil by at least one of the following processes: measuring the electrical resistance of the titanium foil, measuring the electrical resistance of the etching solution, spectrometrically determining the concentration using indicators for acid or titanium compounds.

11. Process according to claim 1, characterized by the foil being a glass foil.

12. Process according to claim 11, characterized by the glass foil being produced by thermal spraying, melting or pouring a glass layer onto a metal carrier or gluing a glass plate to a metal carrier.

13. Process according to claim 12, characterized by:
grinding or polishing or electrolytic polishing the glass layer down to a thickness of between 8 μm and 50 μm before the etching process.

14. Process according to claim 11, characterized by
reducing the thickness of the glass foil or glass layer by etching using hydrofluoric acid or a mixture of an acid and a fluoride salt.

15. Process according to claim 1, characterized by
incorporating the foil in an electron beam accelerator after the etching process.

16. An electron beam exit window produced according to the process of claim 1.

17. An electron beam accelerator comprising
a cathode or an incandescent filament,
an acceleration anode,
a high-voltage source for producing an acceleration voltage applied between the cathode and the acceleration anode,
an electron beam exit window produced according to claim 1.

18. An electron beam accelerator according to claim 17, characterized by the acceleration voltage being less than or equal to 70 kV.

19. An electron beam accelerator according to claim 17 characterized by the electron beam accelerator being used for electron beam curing of varnishes, coating materials, printing inks, adhesives and for re-crosslinking plastics.
